(19) United States
(12) Patent Application Publication
(10) Pub. No.: US 2004/0181494 A1
(43) Pub. Date: Sep. 16, 2004

(54) Apparatus for automatic product code entry into a mail-processing device

(75) Inventor: Katrin Reisinger, Oranienburg (DE)

Correspondence Address: SCHIFF HARDIN, LLP, PATENT DEPARTMENT, 6600 SEARS TOWER, CHICAGO, IL, 60606-6473, US

(73) Assignee: Francotyp Postalia AG & Co. KG

(21) Appl. No.: 10/797,494

(22) Filed: Mar. 10, 2004

(30) Foreign Application Priority Data
Mar. 11, 2003 (DE) 203 04 226.3

(51) Int. Cl. G06F 17/60; G06F 17/00

(52) U.S. Cl. 705/414

(57) ABSTRACT

A mail-processing device has a programmable memory, a program memory, a working memory, a keyboard with operating elements and a microprocessor, and the programmable memory, the working memory and the microprocessor, in combination, are programmable to set an operating mode for automatic product code entry. The microprocessor is programmed with a program for evaluating mail-item-related data value stored in the working memory by means of a table stored in the programmable memory.

### BACKGROUND OF THE INVENTION

1. Field of the Invention

The present invention concerns an apparatus for automatic product code entry into a mail-processing device, particularly for use in postage meter machines, postage scales, mail shipping systems or personal computer (PC) postage meters that are supported by a PC and other mail-processing devices that are suitably formed for data determination for mail class statistics.

2. Description of the Prior Art

A postage meter machine is known from European Patent 493 948 which can print the shipment type as an optional imprint separate from the postage imprint or can print the shipment type and the postage value in an integrated manner, and which is equipped with a number of registers in a security module for storing accounting data which relate to the usage of the postage meter machine for applying postage to articles.

A first set of registers relates to a special first service and a second set of registers relates to a special second service, the special services being selectable via the entry means and the accounting data of the respective selected service being updated. Only certain services are recorded for statement purposes. These statement data do not provide the carrier with sufficient information about the customer behavior.

Some postal authorities/postal carriers now require (or promote using price incentives) the users to make printouts about operations stored in the postage meter machine, for documents/waybill accompanying a mail stack/package or after time period. Such printing includes statements or statistics or receipts for a reloading operation that occurred for increasing the credit balance. Predicting the customer behavior would also be of interest to future postal carriers that will offer new mail services that then have to be billed separately. According to European Application 285 956, a postage meter machine is equipped with a special operations memory and with a connector for an external printer. The user is expected to search out and print only certain data from the stored periodic record of all of the data. To do this, the user has to prepare a separate printer and possibly also reserve a large amount of time to search out and print the data.

New postage meter machines use digitally operating printing units. For example, the T1000 and JetMail® postage meter machines manufactured by Francotyp Postalia AG & Co. KG were the first to employ a thermotransfer printer and an inkjet printer, respectively. This means it is basically possible to also print addresses and other information on a filled envelope in the region of the postage imprint related correspondingly to a service.

Thus, optional prints (texts and/or images) are printed during the postage printing in order to designate the shipment type or form. The format of the storage can be adapted to the needs of a multiplicity of users of one and the same postage meter machine. For example, in some meters a class formation in the form of cost centers is employed, which are allocated to individual user groups.

For printing corresponding reports even without a separate external printer, German OS 42 24 955 discloses a method and an arrangement for internal cost center printing. The printouts, which can be produced for each cost center, contain listings of mail usage of the postage meter machine that can be subdivided by the optional prints. Avoiding the need for an additional printer is advantageous for the user, however, it is not reasonable to expect the user to repeatedly print out lists with data on the usage of the postage meter machine when so requested by the postal carrier or data center, because while printing lists of cost center data using the postage meter machine's internal print head, it is naturally impossible to print postage.

From French Patent 2 665 003, an apparatus for tracking postal usage of an electronic postage metering system is known which is connected to the data center for exchanging electronic messages. Besides the bytes, the message format includes information on the identification, register status and credit status as well as a number of additional bytes for statistical sequencing. The bytes for statistical sequencing contain a division by postage values, by weights or by destinations of the metered mail shipments. A part of the instructions for statistical sequencing can be modified during the communication with the data center, however, the modification of an instruction must take place previously before a statistical recording is initiated. The communication takes place via telephone line or via an electronic module that must be transported physically to the communications partner.

From European Application 717 376, a postage meter machine with a statistics program is known which carries out the transmission of statistical data to the data center via modem and the modification of parameters in the postage meter machine for statistical data recording by downloading new parameters from the data center for definition of the class limits. The possibilities for performing statistics, however, are limited to postage classes.

Due to the multiplicity of services, it is not always clearly evident for which of the services the supplier capacity must be expanded. To some extent, outdated telecommunications systems do not allow high data throughput. In European Application 892368, it was thus proposed to generate, in the data center, selectable combination instructions for class formation and to transmit them in the form of new statistics instruction data to the postage meter machine. The formation of a new statistics mode takes place in the postage meter machine based on the new statistics instruction data and chronologically before the usage of functions and services and their statistical recording in the memory of the postage meter machine. A benefit is the precompression of the data through the combination as well as that a transfer of precompressed data to the data center does not impair the procedure since transfer of the data requires little time.

In European Application 992947, an arrangement and method for storing data by using a terminal device is disclosed, the storage of data in a terminal device and communication with a remote data center having been configured so that the statistics which are subject to different requirements in a country-specific manner can be produced subsequently in the remote data center. The terminal device should not be blocked by the conveyance of statistics. Uninfluenced by the storage and transmission of usage data, the usage of the terminal device for services should be enabled in a service mode.

The postal authorities in some countries will require the ability to make a product code entry (PCE) in future mail-processing devices. The current PCE requirements are graduated differently in a country-specific manner. In Germany, 561 ProductCode categories are specified; in the Netherlands, 11 or 25 or 151 ProductCode categories are specified; and in Canada, 16 or 48 or 72 ProductCode categories are specified. A PCE necessitates an additional entry by the operator. The product categories specified by the governmental mail service should be recognized by the mail-processing device following a manual input and should be stored within the context of the data compilation for mail class statistics (CoM=Class of Mail). The so-called product code entry (PCE) requires corresponding changes in the user interface and in terms of the user prompts in a mail-processing device. The postal authorities in some countries require additionally a weight class entry, which also entails an additional operating expense for the operator.

### SUMMARY OF THE INVENTION

An object of the present invention is to provide a postage meter machine wherein entry of the product code is automated as much as possible. A further object is to provide such a postage meter machine wherein the weight class entry also is automated.

The above object is achieved in accordance with the principles of the present invention in a mail-processing device having a programmable memory, a program memory, a working memory, a keyboard with operating elements and a microprocessor, wherein the programmable memory, the working memory and the microprocessor, in combination, are programmable so as to set an operating mode for automatic product code entry, and wherein the microprocessor is programmed with a program for evaluating mail-item-related data values stored in the working memory by means of a table stored in the programmable memory.

The operator of a mail-processing device already enters shipping information via a keyboard that is needed for computing postage as well as for generating optional prints. Based on these manual entries, the inventive apparatus automatically determines the apparatus product code and stores it in a memory of the mail-processing device. The apparatus can be operated similarly in order to automatically carry out a weight class code entry. The apparatus uses the microprocessor, working memory, program memory and input unit that are already present in the mail-processing device for loading and storing current table values and data which are related to the entry as well as a display and a keyboard with operating elements. The apparatus is, for example, part of a postage scale to which a postage meter machine is connected via an interface. The automatically determined product code and possibly weight class code are buffered in the working memory of the postage scale and then transmitted via the interface to the postage meter machine and stored there in a non-transient manner until queried by a remote data center.

In another configuration, the apparatus can be part of a postage meter machine with integrated postage calculator or of a similar mail-processing device.

According to the invention, moreover, a programmable memory for tables, a working memory for the data values of the shipping parameters of a mail item and a unit for setting a PCE operating mode for automatic product code input are provided and the microprocessor is programmed by a program stored in the program memory to switch to the PCE operating mode. Either via the interface or via an operating element, the setting of the PCE operating mode, e.g., during the initiation or after switching on the device or system, is carried out by the microprocessor responding to the signals delivered to the device via the interface or via an operating element.

In particular, a start address is stored in a non-volatile manner in a programmable memory of at least one first table, which contains several columns, the columns being available to contain data values as well as pointers to further tables.

The program contains corresponding instructions and the microprocessor is programmed to generate screen images at least for entries of shipping parameters for displaying the entry possibilities on the display, and for transient storage of data values of the entries in the working memory. Such data values, e.g., weight values, can be delivered via the interface as well as entered manually. Via this first table, access occurs to further tables, if during evaluation of the data values, a valid row of the table is identified whose data values correspond to the data values stored in the working memory. As in connection with the determination of the product code, a weight class code can be determined and stored in a non-volatile manner in a memory area for usage data in the programmable memory. The latter can be linked to the input unit that is equipped for loading tables into the programmable memory. Thus there is at least one first table with which further tables such as a weight table, product code table, weight class table, etc. can be associated.

### DESCRIPTION OF THE DRAWINGS

FIG. 1 is a block diagram of the inventive apparatus in a mail device.

FIG. 2: is a flowchart for operating the apparatus in accordance with the invention.

### DESCRIPTION OF THE PREFERRED EMBODIMENTS

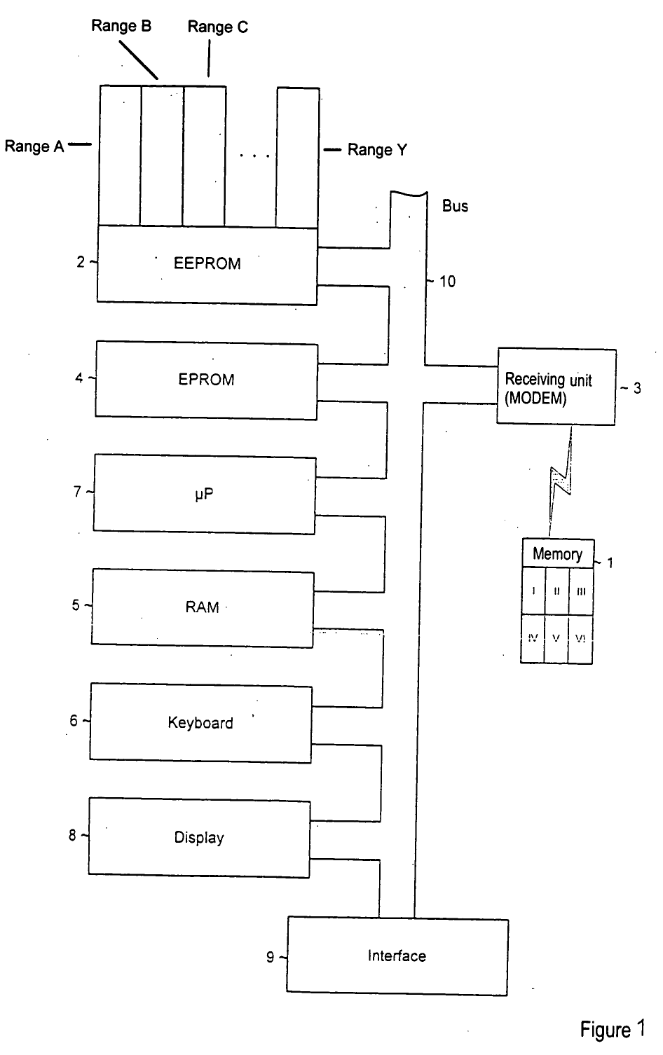

FIG. 1 shows a block diagram of the inventive apparatus in a mail device. The mail device has a programmable memory 2 (EEPROM) which can be connected in an operating manner to an input unit 3 (MODEM) and to a program memory 4 (EPROM), a working memory 5 (RAM) and to an operating unit 6 such as a keyboard, and a microprocessor 7 (μP). The input unit 3, the working memory 5, the operating unit 6 and the microprocessor 7 can be, for example, part of a postage meter machine, an electronic postage scale or a PC-supported mail shipping system. Such devices are generally equipped with a display unit 8 and an interface 9. The components are interconnected, for example, by a bus 10. In the programmable memory 2, at least one table for automatic product code entry is stored and the microprocessor 7 is programmed by an associated application program:

For row-by-row searching through the first and second columns of at least one first table, for invoking program instructions;

For comparison of the data values in the table with the data values of the entries which are stored in the working memory 5, to identify valid shipping parameters which are present in the first and second columns of the at least one first table in the form of data sets; and

For evaluation of the instructions in the remaining columns of the at least one first table, the evaluation taking place for valid shipping parameters in only that row of the at least one first table to which the data values in the working memory 5 correspond.

In another variant (not shown), the input unit 3 can be connected directly via the interface 9.

Via the interface 9, on the one hand (in a manner not shown) a scale can be connected to a postage meter machine or a PC-supported mail shipping system for automatic weight entry. Alternatively, weight entry can be carried out manually using the operating elements 6.

In a further variant (not shown), the input unit 3 can be connected indirectly via the interface 9. Thus, for example, the co-usage of a modem of the postage meter machine by a scale is possible in order to load postal fee tables into the memories of the postage scale. The details of such an interconnection follow from European Patent 724 141.

The programmable memory 2 can be connected for loading tables in an operating manner via the input unit 3 to an external memory 1. The input unit 3 is preferably an analog or digital modem. Alternatively, the input unit 3 can be a drive and the external memory 1 can be a CD or DVD. In a further alternative, the input unit 3 can be a chip card reader and the external memory a chip card. It is also possible for the input unit 3 to be a memory stick interface and the external memory a memory stick. It is only necessary that a suitable data carrier and associated input unit are present.

The data carrier (memory 1) has in one of the memory ranges an application program for automatic product code entry and for generation of screen images, the which program being suitable at least for entries of shipping parameters for displaying entry possibilities on the display 8. At least the first table is stored in the first memory area I and further tables in further memory areas II, III, . . . , VI to which access is enabled via the application program. The at least one first table contains at least columns for data values of correspondingly valid shipping parameters as well as for pointer(s) to a weight table, and for pointer(s) to a product code table.

The application program can be alternatively stored already in the program memory 4.

The microprocessor 7 is programmed by a program:

a) For storing a start address in a programmable memory 2 of at least one first table which has several columns, the columns being available to contain data values as well as pointers to further tables;

b) For generating screen images at least for entries of shipping parameters for displaying the entry possibilities on the display 8;

c) For transient storage of data values of the entries in the working memory 5;

d) For accessing the programmable memory 2 which contains at least the aforementioned first table in a first memory area and further tables in further memory areas, the further tables including at least:

the weight table for determining a table index which is assigned to an entered or measured weight; and

the product code table for determining a product code which is assigned to the table index

For evaluating the data values, that valid row of the table, in terms of the determination of a pointer to partial sections of the product code table, is being evaluated whose data values correspond to the data values stored in the working memory 5; and

For storing the product code which is selected by the above-identified pointer and the table index from the product code table.

The first table can contains pointer(s) to a weight class code table. The programmable memory 2 additionally a weight class table for determining a weight class code stored in a further memory area and that the microprocessor 7 is programmed by a program:

aa) For storing a start address in a programmable memory 2 of at least one first table which contains at least columns for data values of correspondingly valid shipping parameters as well as for pointer(s) to a weight table, for pointer(s) to a product code table and for pointer(s) to a weight class table;

bb) For generating screen images at least for entries of shipping parameters for displaying the entry possibilities on the display 8;

cc) For transient storage of data values of the entries in the working memory 5;

dd) For accessing the programmable memory 2 which contains at least the above-identified first table in a first memory range and further tables in further memory ranges, the further tables including:

the weight table for determining an index in which an index is assigned to [for] the measured or entered weight;

the product code table for determining a product code which is assigned to the index; and

the weight class table for determining a weight class code which is assigned to the index;

ee) For evaluating the data values, that valid row of the table, in terms of the determination of a pointer to partial sections of the product code table and of the determination of a pointer to the weight class table, is evaluated whose data values correspond to the data values stored in the working memory 5; and

ff) For storing the product code and the weight class code which are selected by the above-identified pointer and the table index from the product code table as well as the table index from the weight class code table.

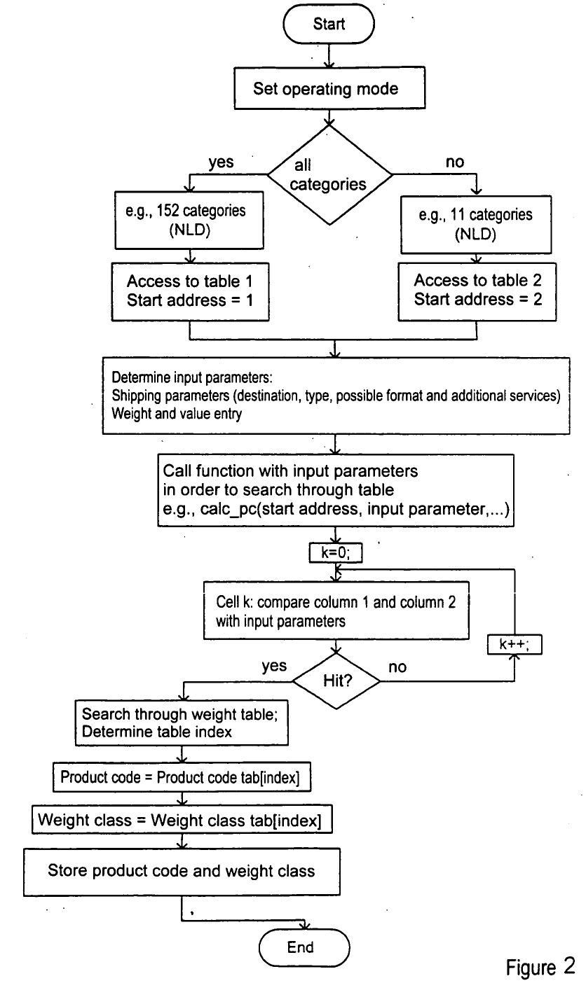

FIG. 2 shows a flowchart for operating the apparatus, which automatically determines based on the shipping parameters set by the operator, a valid product code and a corresponding weight class code. The operating mode has to be set in step 81 only once after the start 80, a selection as to whether a table with all categories (product code) or with a limited number of categories (product code) is to be used. An additional manual entry of product code and weight class code for the respective mail item by the operator thus is unnecessary.

The postage machine determines the setting in step 82 depending on the selection. For example, if it is determined in step 82 that all of the categories should be used or rather not used, then a branch is made in step 83 or rather in step 85 to a corresponding program which makes access to a first table 1 or rather a second table 2 (in step 84 or rather 86).

Automation requires the operator—as usual—to set the mail-item-related shipping parameters in step 87, but further manual entries are unnecessary and the determination of the product code and weight class code automatically proceeds in the background (starting with step 88). The determined quantities of mail-item-related product code and weight class code are transferred at intervals of time automatically to the data center for evaluation. Without additional entries, the operator can use the benefits of the postal services which are offered to the operator if the operator is participating, for example, in the NetSet project in the Netherlands and statistical data are transferred to the data center.

The operator sets the shipping parameters on a postage scale or on a postage meter machine. The shipping parameters are a combination of shipping destination, shipment type, possibly shipment format and any additional capabilities (alternative: services) that might be desired. From a valid combination of shipping parameters, the product code and the weight class code are determined.

In postage scales, first one of the shipping destinations is chosen by the operator in the usual manner. In the Netherlands, for example, “Roodpost”, “Postzegelpost”, “Europa” and “Buiten Europa” etc. can be entered or rather selected in step 87. Subsequently, in a known manner the shipment type (e.g., “Brieven”, “Drukwerk” etc.) is chosen from a second menu. Since the rates for mail shipments to be sent outside of the country are distinguished as “Standard” and “Priority”, for an additional entry a third level has been incorporated as a third menu into the menu selection. Here, it is possible to select “Standard”, “Priority”, “Standard Europese Unie”, “Priority Europese Unie”, “Standard Overig Europa” and “Priority Overig Europa” as well as “Economy” depending on the shipment type. Subsequently, in a known manner the shipment format, e.g., “Aantekenen” or “Verzekernen” etc. is chosen from a fourth menu. The aforementioned menus can be displayed via a screen display in the user interface.

While the operator sets the shipping parameters, the device automatically checks whether the set shipping parameters are valid, i.e., allowed in postal terms. With the postage scale, the weight of the shipment is determined. It is also possible to input the weight via the keyboard if the weight range of the shipment type is greater than the weight range of the scale. For example, if a 5 kg scale is available, but the weight range of the shipment type allows a weight up to 20 kg, the operator has the possibility to enter the weight of the shipment via the keyboard (e.g., 15 kg). For additional services that require, for example, the entry of a value (e.g., insured letter), the operator is requested during the selection of such an additional service to enter the value of the shipment via the keyboard.

The set shipping parameters, and if present, the entered value and the weight of the shipment, form the input parameters for determining the product code and weight class. In the program memory 4, the operating software of the postage scale or the postage meter machine or mailing device is stored. The program memory 4 preferably is designed in a plug-in format, resulting in easy exchangeability and thus adaptation to the different mail requirements in different countries. The operating software delivers instructions for a function of the microprocessor 7 in order to search through a separately stored table with the aid of the input parameters (shipping parameters, weight, value entry) and, from this search, to determine the product code and, if necessary, the weight class code. Alternatively, a data carrier for the programming of the apparatus contains an application program for automatic product code entry in one of its memory areas and the application program can be loaded into a memory area of the programmable memory 2 and stored in a non-volatile manner. The programming takes place oriented especially toward the products or services of the postal carrier in order to form a certain combination of shipping parameters that are stored in the working memory 5 and to compare them with one of the possible products or rather services of the postal carrier. Here, a separately stored table is also searched and from this the product code and, if necessary, the weight class code are determined.

A separate table of this sort, which stores the valid product code for each possible combination of shipping parameters, is accommodated in the separate memory, for example, in memory area II. This separate memory can be a data carrier or an external memory medium 1 with a multiplicity of memory areas I to VI. This table is loaded into a memory (e.g., EEPROM 2) in the postage scale or postage meter machine. The table can also be burned in during the manufacture of the postage scale or postage meter machine in its program memory (EPROM 4). The operating software or the application program knows the memory location and the start address of the table and can access it in this manner.

A product code table will be explained in greater detail based on a table intended for the Netherlands.

TABLE

| Row | Column1 | Column2 | Column3 | Column4 | Column5 | Column6 | Column7 |
|---|---|---|---|---|---|---|---|
| 1 | Z0/ | VZ_M/ | max Σ | (UNIT16*) | (INT32*) | (UCHAR*) | (STRING) |
| | A1/ | VA_M/ | | Weight2 | Prodcode3 | wclass2 | NULL |
| | F1/F3/F4 | VF_M | | | | | |
| 2 | | | | | | | |
| . | . | . | . | . | . | . | . |
| . | . | . | . | . | . | . | . |
| . | . | . | . | . | . | . | . |
| n | | | | | | | |
| . | . | . | . | . | . | . | . |
| . | . | . | . | . | . | . | . |
| . | . | . | . | . | . | . | . |

The table consists of seven columns:

Column 1: Contains the valid shipping parameter combination, e.g., Z0 (=shipment destination)/A1 (=shipment type)/F1/F3/F4 (=additional function), which must be set in order to select this row of the table. Here, the character/stands for an arbitrary type of logical operation.

Column 2: Contains a mask of shipping parameters, e.g., VZ_M (=shipment destination mask)/VA_M (=shipment type mask)/VF_M (=shipment format mask) in order to possibly exclude this row as a hit

Column 3: Contains the maximum value max Σ of an insurance total or rather of the value of the shipping item. This value is zero if a value for the shipping selection is not necessary.

Column 4: Contains a pointer, e.g., (UNIT16*)Weight2 to a weight table. This weight table contains all of the weight graduations for the set shipping parameters.

Column 5: Contains a pointer, e.g., (INT32*)Prodcode3 to the product code table.

Column 6: Contains a pointer to the weight class table, e.g., (UCHAR*)wclass2.

Column 7: Contains a pointer, e.g., (STRING)NULL to a special function that is possibly still to be realized. This value can also equal NULL.

The input parameters for the computation and the corresponding country- or carrier-specific computation function are invoked in step 88. And a row counter is reset to zero (k=0).

Based on the verification of column 1 and column 2, in step 90 a row k is searched for with a valid hit within the table. In each column, a 32-bit data set is stored. That cell which delivers the first valid hit is used for further evaluation. If no hit is determined in query step 91, then in step 92 the row counter status is modified (e.g., incremented) and a branch back to step 90 is made. On the other hand, the row counter status remains unchanged in case of a hit and column 3 is evaluated. It is checked whether the entered insurance sum or value of the shipping item is less than or equal to the maximum value indicated in column 3. If that is not the case, the following rows are investigated for the next hit. The row counter status is then changed.

Otherwise, there is a hit and a pointer in column 4 of that row which provides the valid hit points to a certain weight table. The later is stored in a separate memory area B of the non-volatile memory 2 (EEPROM). A branch is then made to step 93 to search through the weight table and determine a table index.

That weight table to which the pointer in column 4 points is searched until the weight value in the table is found which is closest to the weight determined by the scale or the weight value which was entered via the keyboard, i.e., the next higher weight value in this table is valid. The weight table stores the weight graduations for which different product codes or weight classes apply. The weight graduations might look as follows:

Weight table=0,20,100,250,500,750,1000,1500,2000,5000

It is then investigated into which graduation of the weight table the determined weight value fits. If an entry was found, from this the associated table index is determined which indicates at which location of the table the suitable entry was found.

Subsequently, the (at least one) product code table to which the pointer in column 5 points is investigated in step 94. With the aid of the table index found in the weight table, the corresponding product code is determined in the product code table.

Moreover, in step 95, the already determined table index also can serve, in the weight class table to which the pointer in column 6 points, to determine the corresponding weight class.

Column 7 is currently reserved for possible future applications.

The product code and the weight class code are passed back to the invoking function as parameters and are stored in step 96. If within the table no hit is found which ensues from the shipment destination, shipment type, possibly the shipment form and additional services, then a default product code is transferred back to the invoking function. This default product code is defined depending on the postal service's specification (e.g., in the Netherlands=9999).

Thus, the product code table contains an entry only for the shipping parameters for which a product code must be determined also according to the postal specification. Moreover, there are shipping parameters that are intended to produce a product code that is to be allocated to the category “Miscellaneous”. For these shipping parameters, there are no separate entries in the table. At the end of the table, there is an entry that is read if no hit was found previously. This entry then points to the product code table with the product code for “Miscellaneous”.

The above solution has been described in the example of an implementation specially for the Netherlands. The table can look differently for other country-specific variants. For example, it could be the case that an error code must be produced if no suitable hit Is found for the set shipping parameters in the table.

A postage scale, e.g., of the type FlexiScale®, determines, based on the set shipping parameters such as the destination, type, possibly the format and form, a postage value and the associated product code and the corresponding weight class code. The product code and the weight class code are transmitted along with the postage value to a postage meter machine, such as the type T1000 or Optimail postage meter machines commercially available from Francotyp-Postalia AG & Co. KG, and stored there until the data are queried by a remote data center.

A static scale and its postage scale function was integrated in the postage meter machines of type Jetmail®, Mymail® and Ultimail® into a common housing. Within the context of the FRANKIT requirements of Deutsche Post AG, a product code must also be processed which is enabled in the country-specific variant for Germany for postage meter machines of the above named type. However, this does not differ in basic terms from a product code specified by the postal authority in the Netherlands so that the flow of process steps examined using FIG. 2 can be basically retained also for Germany. The same is true also for further countries whose postal authorities or rather private postal service providers will require the usage of a product code in the future.

Although modifications and changes may be suggested by those skilled in the art, it is the intention of the inventor to embody within the patent warranted hereon all changes and modifications as reasonably and properly come within the scope of her contribution to the art.

I claim as my invention:

1. A mail-processing device comprising:
a programmable memory having a table stored therein;
a program memory;
a working memory having mail-item-related data values stored therein;
a keyboard having a plurality of operating elements;
a microprocessor in communication with said programmable memory, said program memory, said program memory, said working memory, and said keyboard;
said programmable memory, said working memory and said microprocessor, in combination, being programmable to set an operating mode for automatic product code entry; and
said microprocessor being programmed for evaluating said mail-item-related data values stored in said working memory using said table stored in said programmable memory.

2. A mail-processing device as claimed in claim 1 wherein said table in said programmable memory comprises a plurality of columns, each of said columns comprising a plurality of rows, and including first and second columns containing datasets representing defaults for valid shipping parameters, and wherein said microprocessor is programmed for row-by-row searching through said first and second columns to identify datasets in said first and second columns corresponding to said values stored in said working memory and, for the valid shipping parameters represented by said datasets, said microprocessor evaluating structures in remaining columns of said table.

3. A mail-processing device as claimed in claim 2 comprising a display device connected to said microprocessor and wherein said microprocessor is supplied with a weight selected from the group consisting of an entered weight and a measured weight, and wherein said table is a first table stored in a first memory range of said programmable memory, said programmable memory having further memory ranges in which further tables are respectively stored, including a weight table for determining a table index assigned to different weights, and a product code table for determining a product code assigned to said table index, and wherein said microprocessor is programmed for storing a start address of said first table in said programmable memory, for generating a screen image for shipping parameters associated with said values stored in said working memory and for displaying said screen images on said display device, and for accessing said tables in said programmable memory for evaluating data values in a row of said first table in said programmable memory, said data values corresponding to the values stored in said working memory and designating, by a pointer to said product code table, designated product codes, and said microprocessor being programmed for storing the product codes designated by the pointer with the table index for said weight.

4. A mail-processing device as claimed in claim 2 comprising a display device connected to said microprocessor and wherein said microprocessor is supplied with a weight selected from the group consisting of an entered weight and a measured weight, and wherein said table is a first table stored in a first memory range of said programmable memory, said programmable memory having further memory ranges in which further tables are respectively stored, including a weight class table for determining a table index assigned to a weight class code stored in a further memory, and a product code table for determining a product code assigned to said table index, and wherein said microprocessor is programmed for storing a start address of said first table in said programmable memory, for generating a screen image for shipping parameters associated with said values stored in said working memory and for displaying said screen images on said display device, and for accessing said tables in said programmable memory for evaluating data values in a row of a table in said programmable memory, said data values corresponding to the values stored in said working memory and designating, by a pointer to said product code table, designated product codes, and said microprocessor being programmed for storing the product codes designated by the pointer with the table index for a weight class in which said weight occurs.

5. A mail-processing device as claimed in claim 4 comprising a receiver unit for loading and storing table values and data for entry into at least one of said table, said weight table, said product code table and said weight class table.

6. A mail-processing device as claimed in claim 4 for use with a postage meter machine, and comprising an interface adapted for connection to the postage meter machine, and wherein said working memory temporarily stores at least one of said weight class code and said product code in respective memory areas, and wherein said microprocessor is programmed to transmit at least one of said weight class code and said product code to the postage meter machine via said interface.

7. A mail-processing device as claimed in claim 1 comprising an interface in communication with said microprocessor for setting said operating mode.

8. A mail-processing device as claimed in claim 1 wherein one of said operating elements of said keyboard, when actuated, sets said operating mode.

9. An apparatus as claimed in claim 1 comprising a receiving unit connected to said programmable memory for loading said table.

10. A mail-processing device as claimed in claim 9 wherein said receiver unit is a modem selected from the group consisting of analog modems and digital modems.

11. A mail-processing device as claimed in claim 9 wherein said receiving unit is a drive device adapted to receive a data carrier on which said table is stored, selected from the group consisting of CDs and DVDs.

12. A mail-processing device as claimed in claim 9 wherein said receiving unit is a chip card reader adapted to receive a chip card having a memory in which said table is stored.

13. A mail-processing device as claimed in claim 9 wherein said receiving unit is a memory stick interface adapted to receive a memory stick having a memory in which said table is stored.

14. A data carrier for a mail-processing device having a programmable memory, a working memory and a microprocessor programmed to operate in an operating mode for automatic product code entry, and having a receiver unit in communication with the microprocessor, said data carrier having a plurality of memory areas in which are stored, respectively, an application program for said automatic product code entry and for generating screen images for shipping parameters on a display device, at least one first table in one of said memory areas and respective further tables in further memory areas to which access is enabled by said application program, said first table comprising columns of data values for valid shipping parameters and pointers to a weight table, pointers to a product code table and pointers to a weight class table, all of said tables being loadable from data carrier into said programmable memory via said receiver unit.
